SEQUENCE LISTING (10 sequences)

SEQ ID NO: 1 - DNA, 1815 bp, Aspergillus niger
atgcagactctccttgtgagctcgcttgtggtctccctcgctgcggccctgccacactacatcaggagcaatggcattgaagccagcctcctgactgatcccaaggatgtctccggccgcacagtcgactacatcatcgctggtggaggtctgactggactcaccaccgctgcccgtctgacggagaatcccaacatcagcgtgctcgtcatcgaaagtggctcctacgagtcggacagaggtcctatcattgaggacctgaacgcctacggcgacatctttggcagcagtgtagaccacgcctacgagaccgtggagctcgctaccaacaatcaaaccgcgctgatccgctccggaaatggtctcggtggctctactctagtgaatggtggcacctggactcgcccccacaaggcacaggttgactcttgggagaccgtctttggaaatgagggctggaactgggacaatgtggccgcctactccctccaggctgagcgtgctcgcgcaccaaatgccaaacagatcgctgctggccattacttcaacgcatcctgtcatggtaccaatggtactgtccatgccggaccccgtgacaccggcgatgactattcccccatcgtcaaggctctcatgagcgctgtcgaagaccgaggcgttcccaccaagaaggacttcggatgcggtgaccctcatggtgtgtccatgttccccaacaccttgcacgaagaccaagttcgctccgatgccgctcgcgaatggctccttcccaactaccaacgtcccaacctgcaagtcctgaccggacaatatgttggtaaggtgctccttagccagaacggcaccacccctcgtgccgtcggcgtggaattcggcacccacaagggcaacacccacaacgtttacgctgagcacgaggtcctcctggccgcgggctccgctgtctctcccacaatcctggaatattccggtatcggaatgaagtccatcctggagccccttggtatcgacaccgtcgttgacctgcccgtcggcctgaacctgcaggaccagaccaccgctaccgtccgcagccgcatcacctctgctggtgccggacagggtcaggccgcttggttcgccaccttcaacgagacctttggtgactattccgaaaaggcacacgagctgctcaacaccaagctggagcagtgggccgaagaggccgtcgcccgtggcggattccacaacactaccgccttgctcatccagtacgagaactaccgcgactggattgtcaaccacaacgtcgcgtactcggaactcttcctcgacactgccggagtagccagcttcgatgtgtgggaccttctgcccttcacccgaggatacgttcacatcctcgacaaggacccctaccttcaccacttcgcctacgaccctcagtacttcctcaacgagctggacctgctcggtcaggctgccgctactcaactggcccgcaacatctccaactccggtgccatgcagacctacttcgctggggagactatccccggtgataacctcgcgtatgatgccgatttgagcgcctggactgagtacatcccgtaccacttccgtcctaactaccatggcgtgggtacttgctccatgatgccgaaggagatgggcggtgttgttgataatgctgcccgtgtgtatggtgtgcagggactgcgtgtcattgatggttctattcctcctacgcaaatgtcgtcccatgtcatgacggtgttctatgccatggcgctaaaaatttcggatgctatcttggaagattatgcttccatgcag

SEQ ID NO: 2 - protein, 605 aa, Aspergillus niger
MQTLLVSSLVVSLAAALPHYIRSNGIEASLLTDPKDVSGRTVDYIIAGGGLTGLTTAARLTENPNISVLVIESGSYESDRGPIIEDLNAYGDIFGSSVDHAYETVELATNNQTALIRSGNGLGGSTLVNGGTWTRPHKAQVDSWETVFGNEGWNWDNVAAYSLQAERARAPNAKQIAAGHYFNASCHGTNGTVHAGPRDTGDDYSPIVKALMSAVEDRGVPTKKDFGCGDPHGVSMFPNTLHEDQVRSDAAREWLLPNYQRPNLQVLTGQYVGKVLLSQNGTTPRAVGVEFGTHKGNTHNVYAEHEVLLAAGSAVSPTILEYSGIGMKSILEPLGIDTVVDLPVGLNLQDQTTATVRSRITSAGAGQGQAAWFATFNETFGDYSEKAHELLNTKLEQWAEEAVARGGFHNTTALLIQYENYRDWIVNHNVAYSELFLDTAGVASFDVWDLLPFTRGYVHILDKDPYLHHFAYDPQYFLNELDLLGQAAATQLARNISNSGAMQTYFAGETIPGDNLAYDADLSAWTEYIPYHFRPNYHGVGTCSMMPKEMGGVVDNAARVYGVQGLRVIDGSIPPTQMSSHVMTVFYAMALKISDAILEDYASMQ

SEQ ID NO: 3 - DNA, 1497 bp, Acremonium strictum
atggtgcgcatccaagggctcaccgcggccttgagcctcgcctcagccgtccaggcctcatggcttcagaagcgcaactcaatcaacgcctgtctcgccgccgccgacgtcgagttccacgaggaagactccgagggctgggagatggacggcacagccttcaacctccgcgtcgactacgacccagctgccattgccatccctcgctccaccgaggatatcgctgctgctgttcagtgcggtcttgatgctggtgtgcagatctcggccaagggtggtggtcatagctacggttcttacggcttcggtggtgaggatggtcatcttatgttggagttggatcgtatgtaccgtgtgtcggttgatgatgacaatgttgcgactatccagggtggtgctcgtcttggatacactgctcttgagctccttgaccagggtaaccgtgccctgactcacggtacctgccctgctgtcggtattggtggccacgttctcggtggtggctacgggtttgctacccacacccacggtctgaccctggactggctcgtcggtgccaccgtcgtcctggccgatgcctccatcgtgcacgtttccaagactgagaatgctgatctcttctgggccctccgcggcggcggcggtggtttcgccatcgtctctgagttcgagttcaacaccttcgaggctccggagatcatcaccacttaccaggtcaccaccacctggaaccggaaacagcacgttgccggcctcaaggctcttcaggactgggctgagaagaccatgcccagggagctcagcatgcgtcttgagatcaacgcgaacgcccttaactgggagggtaactacttcggtaacgccaaggatcttaagaaggttctgcagcctatcatgaagaaggctggtggcaagtctaccatctccaagcttgttgagaccgattggtacggccagatcaacacctacctgtacggtgccgacctcaacatcacctacaactacgatgtccacgagtacttctacgccaacagcttgaccgctccccgtctctccgacgaagccatctccgccttcgtcgactacaagttcgacaactcctccgtccgccctggccgcggctggtggatccaatgggacttccacggcggcaagaactccgccctggcctcccactccaatgacgagaccgcctacgcccaccgtgaccaactctggctctggcagttctacgacagcatctacgactacgagaacaacacctccccctacccggagagcggcttcgagttcatgcagggcttcgtcgccaccattgaggacaccctcccggaggacaggaagggcaagtacttcaactacgccgataccacgcttgacaaggaggaggcgcagaagctctactggaggggtaaccttgagaagctgcaagctatcaaggccaagtacgatcctgaggatgtgtttggcaatgttgtctctgttgagcccattgcc

SEQ ID NO: 4 - protein, 499 aa, Acremonium strictum
MVRIQGLTAALSLASAVQASWLQKRNSINACLAAADVEFHEEDSEGWEMDGTAFNLRVDYDPAAIAIPRSTEDIAAAVQCGLDAGVQISAKGGGHSYGSYGFGGEDGHLMLELDRMYRVSVDDDNVATIQGGARLGYTALELLDQGNRALTHGTCPAVGIGGHVLGGGYGFATHTHGLTLDWLVGATVVLADASIVHVSKTENADLFWALRGGGGGFAIVSEFEFNTFEAPEIITTYQVTTTWNRKQHVAGLKALQDWAEKTMPRELSMRLEINANALNWEGNYFGNAKDLKKVLQPIMKKAGGKSTISKLVETDWYGQINTYLYGADLNITYNYDVHEYFYANSLTAPRLSDEAISAFVDYKFDNSSVRPGRGWWIQWDFHGGKNSALASHSNDETAYAHRDQLWLWQFYDSIYDYENNTSPYPESGFEFMQGFVATIEDTLPEDRKGKYFNYADTTLDKEEAQKLYWRGNLEKLQAIKAKYDPEDVFGNVVSVEPIA

SEQ ID NO: 5 - DNA, 2355 bp, Humicola insolens
atgaagttcctcggccgtattggggcgaccgcccttgcggcgtcgctgtatctcacatcaggcgccgcgcaagccactggtgatgcgtacaccgactcggaaacaggcattaagttccagacctggtccccggatccgcagttcacttttggccttgccctgccgccggatgccctggagaaggatgccactgagtacattggtcttctccgctgcaccagggccgacccatccgaccctggctactgcggtctctctcatggccaggtcggccagatgacgcagtcgctgcttctcgtggcctgggcctacgagaaccaggtctacacgtcgttccgctacgccaccggctacaccctcccgggtctgtacaccggcaacgctaagctgacccagctctccgtcaacatcaccgacaccagcttcgagctcatctaccgctgcgagaactgcttctcgtgggagcacgaaggcagcaccggatctagctcgacctcccagggctatctcgtcctcggtcgtgcttccgcccgccgcggcgtcgtcggcccgacttgcccggacacggccacctttggtttccacgacaatggcttcggtcagtggggtgttggtctcgagaatgccgtttcggagcagtattctgagtgggcttcgctgccgggtctgactgttgagaccacctgcgaaggatccggccctggtgaggcgcagtgcgtgcctgcccctgaggagacttatgactatattgttgttggtgctggcgccggcggtattcctgtcgccgacaagctgagcgaggccggccacaaggttctgctcatcgagaagggtcccccgtcgacgggccgctggcagggtaccatgaagcccgagtggcttgaaggcactgacctcactcggttcgatgtgcccggcctttgcaaccagatctgggttgactcggctggcattgcctgcactgatactgatcagatggctggctgcgtcttgggcggtggcacggccgttaatgctggcctgtggtggaagcccattgacctcgactgggatgagaacttccctgagggctggcactcgcaggatctcgccgcggcgaccgagcgcgtctttgagcgcatccccggcacctggcacccgtccatggatggcaagctgtaccgtgacgaaggctacaaggttctctccagcggtctggctgagtctggctggaaggaggttgtggccaacgaggttcccaacgagaagaaccgcactttcgcccacacccacttcatgttcgctggcggagagcgtaacgggcctcttgccacttacctggtctctgccgatgcccgcgagaacttctcgctctggaccaacactgctgttcgccgcgctgtccgcactggtggcaaggtcacaggtgtcgagctcgagtgcttgactgatggcggctacagcggcattgttaagctcaatgagggcggtggcgtcatcttctcggccggtgcctttggttcggccaagctgctcttccgcagcggtatcggccctgaggatcagctccgcgttgttgcctcctctaaggacggagaggacttcatcgacgagaaggactggattaagctccccgtcggctacaacctgattgaccaccttaacactgacctcatcctcactcaccccgatgtcgtcttctacgacttctatgaggcctggaccaccccgatcgaggccgacaagcagctgtaccttgagcagcgctctggcatccttgcccaggctgctcctaacattggccccatgatgtgggagcaggtcaccccctcggacggcattacccgccaattccagtggacggctcgcgtcgagggcgacagccgcttcaccaactcttctcatgccatgactctcagccagtacctcggccgtggtgtcgtgtcgcgcggtcgcgccaccatcacccagggtctcgtcaccaccgtggctgagcacccgtacctccacaacgccggcgacaaggaggccgtcattcagggcatcaagaacctcattgagtctcttaacgtgattcccaacatcacttgggtcctgccgcctcctggtagcactgtcgaggaatacgtcgattcgctcctcgtctccgcctcggctcgtcgctcgaaccactggatgggcacggccaagctgggtactgatgatggccgctacggcggtacttcggtcgtcgacctcgacaccaaggtctacggcaccgataacctgttcgtggtggatgcttccatcttccctggcatgtcgaccggcaacccgtccgctatgatcgtgattgccgctgagcaggctgcggagcgcattctgaagctgaggaag

SEQ ID NO: 6 - protein, 785 aa, Humicola insolens
MKFLGRIGATALAASLYLTSGAAQATGDAYTDSETGIKFQTWSPDPQFTFGLALPPDALEKDATEYIGLLRCTRADPSDPGYCGLSHGQVGQMTQSLLLVAWAYENQVYTSFRYATGYTLPGLYTGNAKLTQLSVNITDTSFELIYRCENCFSWEHEGSTGSSSTSQGYLVLGRASARRGVVGPTCPDTATFGFHDNGFGQWGVGLENAVSEQYSEWASLPGLTVETTCEGSGPGEAQCVPAPEETYDYIVVGAGAGGIPVADKLSEAGHKVLLIEKGPPSTGRWQGTMKPEWLEGTDLTRFDVPGLCNQIWVDSAGIACTDTDQMAGCVLGGGTAVNAGLWWKPIDLDWDENFPEGWHSQDLAAATERVFERIPGTWHPSMDGKLYRDEGYKVLSSGLAESGWKEVVANEVPNEKNRTFAHTHFMFAGGERNGPLATYLVSADARENFSLWTNTAVRRAVRTGGKVTGVELECLTDGGYSGIVKLNEGGGVIFSAGAFGSAKLLFRSGIGPEDQLRVVASSKDGEDFIDEKDWIKLPVGYNLIDHLNTDLILTHPDVVFYDFYEAWTTPIEADKQLYLEQRSGILAQAAPNIGPMMWEQVTPSDGITRQFQWTARVEGDSRFTNSSHAMTLSQYLGRGVVSRGRATITQGLVTTVAEHPYLHNAGDKEAVIQGIKNLIESLNVIPNITWVLPPPGSTVEEYVDSLLVSASARRSNHWMGTAKLGTDDGRYGGTSVVDLDTKVYGTDNLFVVDASIFPGMSTGNPSAMIVIAAEQAAERILKLRK

SEQ ID NO: 7 - DNA, 2484 bp, Myceliophthora thermophila
atgaggacctcctctcgtttaatcggtgcccttgcggcggcactcttgccgtctgcccttgcgcagaacaacgcgccggtaaccttcaccgacccggactcgggcattaccttcaacacgtggggtctcgccgaggattctccccagactaagggcggtttcacttttggtgttgctctgccctctgatgccctcacgacagacgccaaggagttcatcggttacttgaaatgcgcgaggaacgatgagagcggttggtgcggtgtctccctgggcggccccatgaccaactcgctcctcatcgcggcctggccccacgaggacaccgtctacacctctctccgcttcgccaccggctatgccatgccggatgtctaccagggggacgccgagatcacccaggtctcctcctctgtcaactcgacgcacttcagcctcatcttcaggtgcgagaactgcctgcaatggagtcaaagcggcgccaccggcggtgcctccacctcgaacggcgtgttggtcctcggctgggtccaggcattcgccgaccccggcaacccgacctgccccgaccagatcaccctcgagcagcacgacaacggcatgggtatctggggtgcccagctcaactccgacgccgccagcccgtcctacaccgagtgggccgcccaggccaccaagaccgtcacgggtgactgcggcggtcccaccgagacctctgtcgtcggtgtccccgttccgacgggcgtctcgttcgattacatcgtcgtgggcggcggtgccggtggcatccccgccgccgacaagctcagcgaggccggcaagagtgtgctgctcatcgagaagggctttgcctcgaccgccaacaccggaggcactctcggccccgagtggctcgagggccacgaccttacccgctttgacgtgccgggtctgtgcaaccagatctgggttgactccaaggggatcgcttgcgaggataccgaccagatggctggctgtgtcctcggcggcggtaccgccgtgaatgccggcctgtggttcaagccctactcgctcgactgggactacctcttccctagtggttggaagtacaaagacgtccagccggccatcaaccgcgccctctcgcgcatcccgggcaccgatgctccctcgaccgacggcaagcgctactaccaacagggcttcgacgtcctctccaagggcctggccggcggcggctggacctcggtcacggccaataacgcgccagacaagaagaaccgcaccttctcccatgcccccttcatgttcgccggcggcgagcgcaacggcccgctgggcacctacttccagaccgccaagaagcgcagcaacttcaagctctggctcaacacgtcggtcaagcgcgtcatccgccagggcggccacatcaccggcgtcgaggtcgagccgttccgcgacggcggttaccaaggcatcgtccccgtcaccaaggttacgggccgcgtcatcctctctgccggtacctttggcagtgcaaagatcctgctgaggagcggtatcggtccgaacgatcagctgcaggttgtcgcggcctcggagaaggatggccctaccatgatcagcaactcgtcctggatcaacctgcctgtcggctacaacctggatgaccacctcaacaccgacactgtcatctcccaccccgacgtcgtgttctacgacttctacgaggcgtgggacaatcccatccagtctgacaaggacagctacctcaactcgcgcacgggcatcctcgcccaagccgctcccaacattgggcctatgttctgggaagagatcaagggtgcggacggcattgttcgccagctccagtggactgcccgtgtcgagggcagcctgggtgcccccaacggcaagaccatgaccatgtcgcagtacctcggtcgtggtgccacctcgcgcggccgcatgaccatcaccccgtccctgacaactgtcgtctcggacgtgccctacctcaaggaccccaacgacaaggaggccgtcatccagggcatcatcaacctgcagaacgccctcaagaacgtcgccaacctgacctggctcttccccaactcgaccatcacgccgcgccaatacgttgacagcatggtcgtctccccgagcaaccggcgctccaaccactggatgggcaccaacaagatcggcaccgacgacgggcgcaagggcggctccgccgtcgtcgacctcaacaccaaggtctacggcaccgacaacctcttcgtcatcgacgcctccatcttccccggcgtgcccaccaccaaccccacctcgtacatcgtgacggcgtcggagcacgcctcggcccgcatcctcgccctgcccgacctcacgcccgtccccaagtacgggcagtgcggcggccgcgaatggagcggcagcttcgtctgcgccgacggctccacgtgccagatgcagaacgagtggtactcgcagtgcttg

SEQ ID NO: 8 - protein, 828 aa, Myceliophthora thermophila
MRTSSRLIGALAAALLPSALAQNNAPVTFTDPDSGITFNTWGLAEDSPQTKGGFTFGVALPSDALTTDAKEFIGYLKCARNDESGWCGVSLGGPMTNSLLIAAWPHEDTVYTSLRFATGYAMPDVYQGDAEITQVSSSVNSTHFSLIFRCENCLQWSQSGATGGASTSNGVLVLGWVQAFADPGNPTCPDQITLEQHDNGMGIWGAQLNSDAASPSYTEWAAQATKTVTGDCGGPTETSVVGVPVPTGVSFDYIVVGGGAGGIPAADKLSEAGKSVLLIEKGFASTANTGGTLGPEWLEGHDLTRFDVPGLCNQIWVDSKGIACEDTDQMAGCVLGGGTAVNAGLWFKPYSLDWDYLFPSGWKYKDVQPAINRALSRIPGTDAPSTDGKRYYQQGFDVLSKGLAGGGWTSVTANNAPDKKNRTFSHAPFMFAGGERNGPLGTYFQTAKKRSNFKLWLNTSVKRVIRQGGHITGVEVEPFRDGGYQGIVPVTKVTGRVILSAGTFGSAKILLRSGIGPNDQLQVVAASEKDGPTMISNSSWINLPVGYNLDDHLNTDTVISHPDVVFYDFYEAWDNPIQSDKDSYLNSRTGILAQAAPNIGPMFWEEIKGADGIVRQLQWTARVEGSLGAPNGKTMTMSQYLGRGATSRGRMTITPSLTTVVSDVPYLKDPNDKEAVIQGIINLQNALKNVANLTWLFPNSTITPRQYVDSMVVSPSNRRSNHWMGTNKIGTDDGRKGGSAVVDLNTKVYGTDNLFVIDASIFPGVPTTNPTSYIVTASEHASARILALPDLTPVPKYGQCGGREWSGSFVCADGSTCQMQNEWYSQCL

SEQ ID NO: 9 - DNA, 1800 bp, Glomerella cingulate
atgaaaaacttgattcccttgtcgctcctcgccacgacagtcgcagcccgacccggatcggcacctcgcgaccaggcagcagccacagcatacgactacattgtcattggaggcggaacgtcgggactcgtggtggccaaccgactctccgaggatgcctccgtctccgtgttggtgattgaggcaggtgattccgtgctcaacaacgcaaacgtcacaaacgccaacggttacggcctcgcgttcggcacggacattgattacgcctatcagaccacagcacagacttacgcaaacaacgcgtcgacaaccttgcgagcagccaaggccctcggaggcacgtccactatcaacggaatggcctacacacgagcggaagcctcgcagatcgatgcctgggagacggtcggcaacgagggttggaactgggatgccctcctcccctattacctcaagtcggagaccttccaggcacccgacgcagaacgctcgattaagggccatatctcgtatgagtcggacgtgcacggtcatgatggtccgctctacaccgcatacgcctatggatcgaccaacgactcgtaccccacctcgctcaacgcaacctaccaggcgctcaacgtcccctggaaagaggatatcgcaggcggttcgatggtgggcttcgcgtcgtatcccaagacactcaaccaggacttgaacatccgatgggatgcagcgagggcgtactacttcccctacgagaacaggaccaacctcaaggtcgtcctcaacacaaccgcaaagaaactcacatgggcgtccgcaaccaacggcaccgatgccacagcgtcgggagtggagatcactgcagccgatggcaccacttccgtcgtcaccgcaaacaaagaggtgattatctccgcaggagcgctcgtgtcgcccttgctcttggagctctcgggagtgggcaaccctgcatggctctcccagtatggaatcgagacagtcgtcgagctccctactgtcggtgaaaacttgcaggaccagatcaacaacgagttgatctattcccctccgacaaacttcacatcgacgtacgattccggagtcggagcattcgtggcctacccgtcggcgtcgcacgtcttcggaaccaacgaatcgtccgcctccgaagagttgaagtcgcagctcactgcctacgcagacaccgtggcgatcgccaacggcaacgtcacaaaggcgtcggatctcctcgatttcttccagctccagtatgacctcatcttcaaagatcaggtgcctttcgcagaggtcttgatctatatcgccaaaggctcctggggagcagagtactggggactcctccctttctcgcgaggctccattcatatctcccaggcaaactcgacagcaggtgcattgatcaaccccaactacttcatgctcgattacgatgtcgaattgcaggtggccacggccaaattcatccggtcggtgttcggcacaggaccgttcgcgtccgtggcaggcactgagacaacacctggcttcgatgtgattcccgcagatgcggatgaggcgacctggaaatcctgggcgaccaaggagtaccggtccaacttccatcctgtggcaactgcggcaatgctccctaaagagaagggaggcgtcgtcgacgcgcagctcaaggtgtatggcacgaccaacgtgcgggtggtggatgcctcggtgctccccttccaggtgtgtggccacttggtgtccacgctctacgccgtggccgagaaggcgtcggacttgatcaaagcagcagcg

SEQ ID NO: 10 - protein, 600 aa, Glomerella cingulata
MKNLIPLSLLATTVAARPGSAPRDQAAATAYDYIVIGGGTSGLVVANRLSEDASVSVLVIEAGDSVLNNANVTNANGYGLAFGTDIDYAYQTTAQTYANNASTTLRAAKALGGTSTINGMAYTRAEASQIDAWETVGNEGWNWDALLPYYLKSETFQAPDAERSIKGHISYESDVHGHDGPLYTAYAYGSTNDSYPTSLNATYQALNVPWKEDIAGGSMVGFASYPKTLNQDLNIRWDAARAYYFPYENRTNLKVVLNTTAKKLTWASATNGTDATASGVEITAADGTTSVVTANKEVIISAGALVSPLLLELSGVGNPAWLSQYGIETVVELPTVGENLQDQINNELIYSPPTNFTSTYDSGVGAFVAYPSASHVFGTNESSASEELKSQLTAYADTVAIANGNVTKASDLLDFFQLQYDLIFKDQVPFAEVLIYIAKGSWGAEYWGLLPFSRGSIHISQANSTAGALINPNYFMLDYDVELQVATAKFIRSVFGTGPFASVAGTETTPGFDVIPADADEATWKSWATKEYRSNFHPVATAAMLPKEKGGVVDAQLKVYGTTNVRVVDASVLPFQVCGHLVSTLYAVAEKASDLIKAAA

(19) United States
(12) Patent Application Publication
(10) Pub. No.: US 2016/0249669 A1
(43) Pub. Date: Sep. 1, 2016

(54) METHOD FOR DECOLORIZATION OF SUGAR SOLUTION USING ENZYMES

(71) Applicant: NOVOZYMES A/S, Bagsvaerd (DK)

(72) Inventors: Kirk Matthew Schnorr, Holte (DK); Eduardo A. Borges da Silva, Sao Jose (BR); Miguel D.G.P. Toscano, Frederiksberg (DK); Smitha Prabhakar, Davanagere (IN)

(73) Assignee: NOVOZYMES A/S, Bagsvaerd (DK)

(21) Appl. No.: 15/028,652

(22) PCT Filed: Oct. 10, 2014
(86) PCT No.: PCT/EP2014/071759

§ 371 Date: Apr. 11, 2016

(30) Foreign Application Priority Data
Oct. 11, 2013 (EP) 13188306.8
Sep. 4, 2014 (IN) 4354/CHE/2014

(51) Int. Cl. A23L 2/84; C13B 20/00; A23L 2/02

(52) U.S. Cl. CPC A23L 2/84; A23L 1/277; A23L 2/02; C13B 20/002; A23V 2002/00

(57) ABSTRACT

The present invention relates to methods for decolorizing a sugar solution obtained from sugar crops, wherein the solution is treated enzymatically with an oxidoreductase resulting in a decrease in color and/or turbidity of the solution. Also described are methods for decolorizing fruit juice solutions using oxidoreductases. Specifically, glucose oxidase, carbohydrate oxidases, glucose dehydrogenase, cellobiose dehydrogenase and glucooligosaccharide oxidase are described. At least action of glucose oxidase results in the formation of a coloured precipitate, which may be removed by filtration or centrifugation.

### REFERENCE TO SEQUENCE LISTING

This application contains a Sequence Listing in computer readable form. The computer readable form is incorporated herein by reference.

### FIELD OF THE INVENTION

The present invention relates to a method for decolorization of sugar solutions derived from sugar crops, in the production of sugar. Particularly, the present invention provides a method for enzymatically removing colored impurities or precursors of color in the production of sugar. The invention also relates to the removal of color from sugar containing juices for the fruit juice industry. In particular apple, pear, pineapple and papaya juice as well as their concentrates.

### BACKGROUND OF THE INVENTION

Refined white sugar primarily contains sucrose, with most polysaccharides and other non-sucrose compounds removed. Raw sugar typically includes polysaccharides and other compounds in addition to sucrose which include colorant and impurities. The presence of color in raw sugar plays a key role in the marketing strategy of the raw sugar industry. Some raw sugars are relatively difficult to decolorize and even can develop color during storage. In the case of sugar containing juices such as apple and apple juice concentrates, color stability during storage is a major concern. In traditional processes, the clarified juice is decolorized, typically by adsorption of impurities onto activated carbon, charcoal, or ion exchange resins prior to evaporative concentration.

In the conventional method of producing refined sugar from either sugarcane or sugar beet raw materials, initially a raw sugar is produced at the mill by crystallization from juice extracted from sucrose containing raw materials, with a single or a combination of multiple clarification treatments. The raw sugar is later refined by either washing or affined; “melted” (i.e., dissolved in hot water); and then clarified to remove polysaccharides and colloids. Conventional clarification is usually performed by liming, sulphitation, carbonation, and phosphatation (Madho, S and Davis, S B, Review of proven technologies available for the reduction of raw sugar colour; Proc. S Afr. Sug. Technol. Ass (2008)). Studies involving the use of enzymes for removal of color, turbidity and total polysaccharides in sugar beet and sugarcane juice have been performed as described in Laboratory Studies on the Effect of Enzymes on Color, Turbidity and Total Polysaccharides in Sugar beet and Sugarcane Juice, Mckee, M., Moore, S., Triche, R., Richard, C. and Godshall, M. A., presented at the 34th ASSBT Meeting in Salt Lake City, Utah, on Feb. 28-Mar. 3, 2007, pp. 188-196. It was observed that up to 31% color could be removed from sugar beet juice with the addition of a commercial xylanase enzyme preparation and less than 20% color could be removed from cane juice. The enzymes used in the study were commercial blends of enzymes sold for their hydrolytic enzyme activity. The hydrolytic enzyme activities in the commercial samples were cellulases, glucosidases, xylanases, pectinases, hemicellulases and glucanases.

In the prior art, it has also been suggested to add H₂O₂ to chemically remove color from raw sugar (reviewed by Madho, S and Davis, S B, Review of proven technologies available for the reduction of raw sugar color; Proc. S Afr. Sug. Technol. Ass (2008); pp 175-176). CN101768644 disclose a method for removing color from sugar juice by the addition of, high amounts of chemical peroxide together with a plant peroxidase, resulting in conversion of phenols in the sugar juice to quinones. The quinones are reactive and precipitate with each other. WO2012/019266 describes a method for removing malanoidins from sugar solutions by the action of chemical agents.

Traditional refining methods suffer from high energy costs, high chemical reagent costs, and high waste disposal costs. The costs of refining are directly proportional to the color content in the raw sugar and therefore a decreased market value applies to raw sugar with higher color content. Hence the sugar refineries require raw sugars that are easy to decolorize and have low impurity loading.

Color impurities are also undesirable in other industries such as in the fruits juice concentrate industry. Apple juice concentrate, or AJC, is a global commodity which is used as a sweetening additive for foods and beverages. AJC is a clarified product in which the pressed apple juice is filtered. This filtrate is then treated with activated carbon and/or ion exchange in order to remove colors and impurities. The treated juice is then concentrated by evaporation to about 70° Brix after which, it is stored under refrigeration until use. Color stability is an issue in AJC with darkening of the concentrate occurring during prolonged storage of several months. Darkened AJC must then be re-diluted and the color removed by activated carbon or ion exchange before evaporative re-concentration to 70° Brix. By using enzymes of the invention, inclusion of sufficient quantities of enzymes such as glucose oxidase or cellobiose dehydrogenase can precipitate the color into aggregates that can be filtered out instead of using cost intensive activated charcoal or ion exchange.

The present invention describes methods for enzymatic decolorization of sugar solutions in the sugar extraction and refining process, as well as enzymatic removal of color from concentrated fruit juice.

### SUMMARY OF THE INVENTION

The present inventors have discovered that enzymatic decolourization can be obtained by adding oxidoreductases including both oxidases and dehydrogenases to sugar solutions obtained from sugar crops as well as to fruit juice and fruit juice concentrates.

The invention provides in a first aspect a method for decolorizing a sugar solution obtained from sugar crops, wherein the solution is treated enzymatically with a glucose oxidase (EC 1.1.3.4), carbohydrate oxidases (EC 1.1.3) or a dehydrogenase resulting in a decrease in color and/or turbidity of the solution.

In a second aspect, the invention provides a method for decolorizing a fruit juice or fruit juice concentrate, wherein the fruit juice or fruit juice concentrate is treated enzymatically with glucose oxidase (EC 1.1.3.4), or other suitable carbohydrate oxidases (EC 1.1.3) resulting in a decrease in color of the fruit juice or fruit juice concentrate.

In a third aspect, the present invention provides a method for preventing color formation during cold storage of fruit juice concentrate, wherein the fruit juice concentrate is treated enzymatically with glucose oxidase (EC 1.1.3.4), or other suitable carbohydrate oxidases (EC 1.1.3).

### DEFINITIONS

Oxidoreductase: An enzyme that catalysis the transfer of electrons from one molecule (the reductant or electron donor) to the oxidant (or electron acceptor).

Oxidase: An enzyme that performs an oxidation/reduction reaction in which the electron acceptor is molecular oxygen. In such a reaction, the oxygen is converted to water or hydrogen peroxide.
Dehydrogenase: An enzyme that oxidizes a substrate by a reduction reaction that transfers one or more hydrides (H−) to an electron acceptor.
Raw sugar: Solid crystalline sugar resulting from crystallization of sugar containing solutions away from other components found in such solutions.
Raw juice: Any juice derived from intermediate streams before the evaporation step at sugar cane and beet mills.
Mixed juice: Thee juice resulting from the primary juice extraction of the sugar crop.
Clear juice: The juice resulting from the clarification step which subsequently goes into the evaporators.
Sugar solution: Any solution containing simple sugars such as sucrose, glucose or fructose.
For the context of the present invention relevant sugar solutions would be derived from sugar crops used in the sugar industry for the production of raw sugar.
Sugar crops: Crops used for the production of raw sugar and in particular are selected from the group consisting of sugar cane, sugar beet, and sweet sorghum.
Turbidity: Haziness found in some solutions due to the presence of suspended solids.
ICUMSA color: The value of the absorbancy index multiplied by 1000, designed as ICUMSA Units at pH 7 (IU_{7.0})
Decolorization: Removal of either suspended solids or chromogenic (color forming) components from a material resulting in a product that has significantly less color. Decolorization in the context of the present invention can be measured photometrically. Decolorization (or color reduction) as used herein means a decrease in absorption of light determined according to the ICUMSA standards and described in the ICUMSA Methods Book (2009), Verlag Dr. Albert Bartens KG, Berlin, 2010, ISBN 978-3-87040-553-3 and Supplement ISBN 978-3-87040-563-2). This method determines an attenuation index, determined by absorption of light under defined conditions. Generally measured using the ICUMSA method at 420 nm, and referred to as ICUMSA units or IU.
Malanoidin: Melanoidins are brown, high molecular weight heterogeneous polymers that are formed when sugars and amino acids combine (through the Maillard reaction) at high temperatures (typically 140-165° C.) and low water activity.
Absorbancy: The quantity of light that a solution neither transmits nor reflects, proportional to the concentration of colorants in a solution. Used to qualify/quantify the product regarding its color.
Transmittance: The ratio of the intensity of the light that has passed through the solution to the intensity of the light when it entered the solution. Used to qualify/quantify the product regarding its colour.
Sequence identity: The relatedness between two amino acid sequences or between two nucleotide sequences is described by the parameter “sequence identity”.

For purposes of the present invention, the sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 5.0.0 or later. The parameters used are gap open penalty of 10, gap extension penalty of 0.5, and the EBLOSUM62 (EMBOSS version of BLOSUM62) substitution matrix. The output of Needle labeled “longest identity” (obtained using the -nobrief option) is used as the percent identity and is calculated as follows:

(Identical Residues×100)/(Length of Alignment−Total Number of Gaps in Alignment)

For purposes of the present invention, the sequence identity between two deoxyribonucleotide sequences is determined using the Needleman-Wunsch algorithm (Needleman and Wunsch, 1970, supra) as implemented in the Needle program of the EMBOSS package (EMBOSS: The European Molecular Biology Open Software Suite, Rice et al., 2000, supra), preferably version 5.0.0 or later. The parameters used are gap open penalty of 10, gap extension penalty of 0.5, and the EDNAFULL (EMBOSS version of NCBI NUC4.4) substitution matrix. The output of Needle labeled “longest identity” (obtained using the -nobrief option) is used as the percent identity and is calculated as follows:

(Identical Deoxyribonucleotides×100)/(Length of Alignment−Total Number of Gaps in Alignment)

### DETAILED DESCRIPTION OF THE INVENTION

The present invention describes an enzymatic process to remove color and color precursors from sugar solutions obtained from sugar crops. The method is also suitable for removing color from fruit juices. With the use of enzymatic treatment of sugar solutions, color and/or turbidity can be significantly reduced thereby reducing or even eliminating the use of chemical bleaching agents, flocculants or ion exchange resins that are traditionally used to remove color in the production of sugar.

The enzymatic treatment results in a substantially decolorized sugar solution that will be easier to process into high quality refined sugar products. In the case of fruit juices or their concentrates, products with reduced darkening or color formation especially during prolonged storage may be obtained.

Raw sugar is the solid crystalline product typically derived from the Sugar Mill, where the sugar enriched raw materials are processed to extract the sugar content.

The raw material at the processing plant is washed and chopped into small pieces (cane stalks) or strips (beet roots) so as to have the right characteristics for milling or diffusion; notably that the juice can be easily extracted. The sucrose-contained juice is separated from the remainder of the prepared raw material by extraction in a set of crushing mills (or in a diffuser). For a review see, e.g., Sugar Technology: Beet and Cane Sugar Manufacture, Authors: Pieter Willem van der Poel, Hubert M. Schiweck, Thomas K. Schwartz; Verlag Dr Albert Bartens KG, 1998. While the milling is the predominant extraction process in sugar production from cane sugar, the diffuser systems are governing the extraction of sucrose from sugar beet. In the mills, a milling tandem squeezes the sugar containing raw material under high pressure between successive pairs of rolls (imbibition water across the bagasse flow enables to extract more sucrose). Diffusers are known to be capable of achieving higher sugar extraction than mills (up to 98%). The driving force for sucrose mass transfer from raw material to extracting liquid corresponds to the concentration gradient until equilibrium. Generally, this technology uses a continuous countercurrent extraction process, in which the juice is pumped and recirculated onto the moving bed of well-prepared raw material, about 50-60 m long, in 10 to 18 stages. On average, the color of juice from a diffuser is about 10% to 20% higher than juice from the mill “REF: Rein P. W. (1999) A review of cane diffusion in South Africa sugar Mills. Intern. Sugar J. 101 (1204) p. 192-196 & 232-200.” The primary juice is obtained from the first extraction. Water is applied at 60 to 80° C. in an opposite direction to the fiber movement during the milling (or diffuser) which allows for the efficient sucrose extraction from the matrix. The mixture of primary juice with the secondary juice from the rest of the mills is often referred to as mixed juice (or draft juice that is the denomination when it comes from diffuser process). The pH of the juice, at this stage, is in the range of 4.8 to 6 depending on the quality and condition of the cane.

Raw juice (any juice derived from intermediate streams before the evaporation step at sugar cane and beet mills) containing a sugar concentration up to 17° Brix passes through a screening process to reduce the amount of insoluble solids before the clarification. Clarification is an important step in the process of the raw sugar manufacture and is where soluble and insoluble non-sugar compounds are removed from the raw juice with the aim of lowering of its color (determined by ICUMSA Method GS1/3-7 (2002)) and/or turbidity (determined by ICUMSA Method GS7-21 (2007)). After the extraction of the sugar-enriched juice at processing plants, some of its components such as chlorophyll, phenolic compounds, anthocyanin, amino acids and other non-sugar color producing matter are removed. Industrial juice clarification can consist of one single treatment or a combination of multiple treatments. The exact clarification regime depends on a number of factors including the intended use of the sugar and the geographic region. Treatment with lime solutions (defecation with calcium phosphate), sulfitation (use of SO₂ gas), phosphatation (use of soluble phosphate, also applied to the clarification of refinery syrups), carbonation (use of carbon dioxide, more common for clarification and decolorization of refinery syrups) remain the normal methods employed at industrial plants.

The main mechanism for the removal of the impurities is through the precipitation (formation of flocs) based on the reaction of Ca+ and inorganic acids (PO₄³⁻, SO₄²⁻, silicates) and subsequently the precipitated particles are separated by sedimentation, flotation and/or filtration. Heating the juice up to the boiling point enhances flocculation, the coagulation of proteins, and the removal of dissolved air.

The decanted (or clarified) juice (now at pH 6.8 to 7.0) passes through an evaporator system (multiple effect evaporator) to raise its dissolved solid content (approximately 65 to 70° Bx). Eventually, flotation clarification is employed on the syrup from evaporator in raw sugar mills leading to improvements in sugar quality. The concentrated syrup is sent to vacuum pans to an additional evaporation and subsequent supersaturation of sucrose solution. Hence, a mixture of sugar syrup and crystals (called massecuite) is formed and dropped into a centrifugal separator to recover the sucrose crystals from the syrup.

At the end, the solid sugar is typically washed to reduce its color (with the removal of molasses film covering the crystals).

The present invention provides in a first aspect a method for decolorizing a sugar solution obtained from sugar crops, wherein the sugar solution is treated enzymatically with an oxidoreductase resulting in a decrease in color and/or turbidity of the solution.

In one particular embodiment, the oxidoreductase treatment results in a decrease in color of the solution.

In another particular embodiment, the oxidoreductase treatment results in a decrease in turbidity of the solution.

The oxidoreductase is in a particular embodiment selected from the group consisting of glucose oxidase (EC 1.1.3.4), carbohydrate oxidases (EC 1.1.3) or a dehydrogenase. In the examples several enzymes representing each class of enzymes have been shown to be effective in color reduction. In particular these enzymes have been shown to be able to reduce color from sugar solutions in which the color present is not caused by melanoidins. Melanoidins are formed by a Maillard reaction as a result of reducing sugars reacting with amino acids at high temperatures, usually around 140-165° C. In the sugar plant this type color would therefore normally not be present in the sugar solution if the enzymatic treatment takes place before the evaporation step.

Therefore, in one embodiment, reduction in color is obtainable when the glucose oxidase, carbohydrate oxidase, or dehydrogenase is added at any step before evaporation in a sugar production process.

In another embodiment the reduction in color is obtained by removal of color which is not a melanoidin.

The efficiency of the enzymatic treatment depends on the availability of suitable enzymes having the desired activity ansd stability, and thus the amount of color removed by the process may vary. However, in one embodiment, at least 20%, at least 25%, at least 30%, at least 35%, particularly at least 40%, more particularly 45%, even more particularly at least 50% of the color is removed.

The sugar solution is preferably obtained from any sucrose containing sugar crops, such as, e.g., sugar cane, sugar beet, and sweet sorghum. Preferably the sugar solution is obtained from sugar cane.

The sugar solution may be obtained from different stages in the above described sugar process eventually resulting in raw sugar or from the refinery streams in the refinery where refined sugar is produced from raw sugar. E.g., the sugar solution may in one embodiment be selected from the group consisting of raw juice, primary juice, secondary juice, mixed juice, sulphited juice, limed juice, decanted juice, clear juice, floated juice, clarified juice, raw sugar solution, VHP sugar solution (very highly polymerized), VVHP sugar solution, and white sugar solution.

In a particular embodiment, the enzymatic treatment of the invention is applied after the juice extraction on the mixed juice and before or during clarification. In another particular embodiment the enzymatic treatment of the invention is applied on the clear juice after clarification and before evaporation. In another particular embodiment the enzymatic treatment of the invention is applied on the syrup after evaporation and before crystallization. In another particular embodiment the enzymatic treatment of the invention is applied on the raw sugar after melting and before crystallization.

In one embodiment, the enzymatic treatment may therefore be applied to sugar solutions at any suitable stage during the production process of raw sugar or refined sugar. However, the method of the invention may also be applied to other sugar products in which color removal may be advantageous. The sugar products may be selected from the list comprising Brown Sugar, Burnt Sugar, Caramelized Sugar, Caster (Castor) Sugar, Coarse Sugar, Confectioner's Sugar, Demerara-style Sugar, Evaporated Cane Sugar, Fondant Sugar, Fruit Sugar, Golden Syrup, Golden Yellow Sugar, Granulated Sugar, Icing Sugar, Liquid Invert Sugar, Liquid Sugar, Molasses, Muscovado Sugar, Organic Sugar, Pearl Sugar, Plantation ‘Raw’ Sugar, Powdered Sugar Raw Sugar, Refined Sugar syrup, Refiner's Syrup, Sanding Sugar, Soft Sugar, Sugar, Superfine Sugar, Table Sugar, Turbinado-style Sugar, White sugar.

Suitable oxidoreductase enzymes to be applied according to the invention include oxidases and dehydrogenases. In a particular embodiment the oxidases comprise glucose oxidase (EC 1.1.3.4), or other suitable carbohydrate oxidases (EC 1.1.3).

More particularly the oxidase is an Aspergillus niger glucose oxidase, and preferably the oxidase disclosed as the mature polypeptide of SEQ ID NO: 2, particularly amino acids 17-605 of SEQ ID NO: 2 or a polypeptide having a sequence identity to amino acids 17-605 of SEQ ID NO: 2 of at least 85%, at least 90%, at least 91%, at least 92%, at least 93%, at least 94%, at least 95%, at least 96%, at least 97%, at least 98%, at least 99%, or 100%, which have glucose oxidase activity. In another particular embodiment the oxidase is an Acremonium strictum carbohydrate oxidase, and more particularly the oxidase disclosed as the mature polypeptide of SEQ ID NO: 4, particularly amino acids 20-499 of SEQ ID NO: 4 or a polypeptide having a sequence identity to amino acids 20-499 of SEQ ID NO: 4 of at least 85%, at least 90%, at least 91%, at least 92%, at least 93%, at least 94%, at least 95%, at least 96%, at least 97%, at least 98%, at least 99%, or 100%, which have carbohydrate oxidase activity.

In another particular embodiment, the dehydrogenase is selected from the group consisting of glucose dehydrogenase (EC 1.1.99.10), cellobiose dehydrogenase (EC 1.1.99.18), glucooligosaccharide oxidase (EC 1.1.99.B3) or other suitable carbohydrate dehydrogenases (EC 1.1.99). In a particular embodiment the dehydrogenase is selected from the group consisting of Humicula insolens cellobiose dehydrogenase, particularly the mature cellobiose dehydrogenase of SEQ ID NO: 6, particularly amino acids 24-785 of SEQ ID NO: 6, or a polypeptide having a sequence identity to amino acids 24-785 of SEQ ID NO: 6 of at least 85%, at least 90%, at least 91%, at least 92%, at least 93%, at least 94%, at least 95%, at least 96%, at least 97%, at least 98%, at least 99%, or 100%, which have cellobiose dehydrogenase activity. In another particular embodiment a Myceliopthora thermophile cellobiose dehydrogenase, more particularly the mature cellobiose dehydrogenase of SEQ ID NO: 8, particularly amino acids 22-828 of SEQ ID NO: 8, or a polypeptide having a sequence identity to amino acids 22-828 of SEQ ID NO: 8 of at least 85%, at least 90%, at least 91%, at least 92%, at least 93%, at least 94%, at least 95%, at least 96%, at least 97%, at least 98%, at least 99%, or 100%, which have cellobiose dehydrogenase activity. In another particular embodiment a Glomerella cingulata glucose dehydrogenase, more particularly the mature glucose dehydrogenase of SEQ ID NO: 10, particularly amino acids 17-600 of SEQ ID NO: 10, or a polypeptide having a sequence identity to amino acids 17-600 of SEQ ID NO: 10 of at least 85%, at least 90%, at least 91%, at least 92%, at least 93%, at least 94%, at least 95%, at least 96%, at least 97%, at least 98%, at least 99%, or 100%, which have glucose dehydrogenase activity.

It is well known that glucose oxidases by their action will generate hydrogen peroxide. It is also known that hydrogen peroxide can be used to remove color from raw sugar solutions (Madho, S and Davis, S B, Review of proven technologies available for the reduction of raw sugar colour; Proc. S Afr. Sug. Technol. Ass (2008), pp. 175-176). However, in order to achieve sufficient color removal effect the hydrogen peroxide has to be applied in relatively large amounts. The amount of enzyme added according to the present invention is, however, not generating sufficient hydrogen peroxide to explain the observed decolorizing effect and it was therefore surprising that the enzymatic method according to the invention turned out to be efficient in color removal. The inventors of the present invention have shown that enzymatic removal of the generated hydrogen peroxide by the enzymatic action of catalase did not significantly change the color removing effect of the tested oxidoreductases.

In a particular embodiment of the invention the enzymatically produced hydrogen peroxide is insufficient to result in an equivalent reduction in turbidity. This was verified by adding catalase (EC 1.11.1.6) to the reaction mixture, an enzyme which converts 2H₂O₂ to O₂ and 2H₂O (see example section).

The enzymes suitable for the method according to the invention should have sufficient activity at a suitable pH range. This may depend on at which point during the sugar refining process the color removal is desirable. Typically sugar solutions have a pH in the range from 3-7, more particularly in the range from 4-6.5, particularly 4.8-6 or 6.6-7, particularly 6.8-7.

In another aspect, the invention relates to a method for decolorizing a fruit juice or fruit juice concentrate, wherein the fruit juice or fruit juice concentrate is treated enzymatically with an oxidoreductase resulting in a decrease in turbidity of the solution.

In a particular embodiment, the fruit juice or fruit juice concentrate has been subjected to a separation step, e.g., filtration or centrifugation, before the enzymatic treatment.

The fruit juice or fruit juice concentrate is in a specific embodiment obtained from apple, pear, pineapple or papaya.

Suitable oxidoreductase enzymes to be applied according to the invention include oxidases.

In a particular embodiment, the oxidases comprise glucose oxidase (EC 1.1.3.4), or other suitable carbohydrate oxidases (EC 1.1.3).

More particularly the oxidase is an Aspergillus niger glucose oxidase, and preferably the oxidase disclosed as the mature polypeptide of SEQ ID NO: 2, particularly amino acids 17-605 of SEQ ID NO: 2 or a polypeptide having a sequence identity to amino acids 17-605 of SEQ ID NO: 2 of at least 85%, at least 90%, at least 91%, at least 92%, at least 93%, at least 94%, at least 95%, at least 96%, at least 97%, at least 98%, at least 99%, or 100%, which have glucose oxidase activity. In another particular embodiment the oxidase is an Acremonium strictum carbohydrate oxidase, and more particularly the oxidase disclosed as the mature polypeptide of SEQ ID NO: 4, particularly amino acids 20-499 of SEQ ID NO: 4 or a polypeptide having a sequence identity to amino acids 20-499 of SEQ ID NO: 4 of at least 85%, at least 90%, at least 91%, at least 92%, at least 93%, at least 94%, at least 95%, at least 96%, at least 97%, at least 98%, at least 99%, or 100%, which have carbohydrate oxidase activity.

Since color stability is an issue in particular for apple juice concentrate, AJC, with darkening of the concentrate occurring during prolonged storage of several months it is an aspect of the present invention to avoid the color formation during storage. Thus in a further aspect the present invention relates to a method for preventing color formation during cold storage of fruit juice concentrate, wherein the fruit juice concentrate is treated enzymatically with an oxidoreductase.

For fruit juice, the color removal may in one embodiment result in precipitation of colored compounds in the form of, e.g., polyphenols, which compounds may be subsequently remove by a separation step. Therefore in one embodiment a separation step is included after the enzymatic treatment. In one particular embodiment the separation step is filtration.

In a particular embodiment, the fruit juice concentrate is apple juice concentrate.

The present invention is further described by the following numbered paragraphs:

[1] A method for decolorizing a sugar solution obtained from sugar crops, wherein the solution is treated enzymatically with an oxidoreductase resulting in a decrease in color and/or turbidity of the solution.
[2] The method according to paragraph 1, wherein the sugar solution is obtained from any sucrose containing sugar crops, such as, sugar cane, sugar beet, sweet sorghum.
[3] The method according to paragraph 1 or 2, wherein the sugar solution is selected from the group comprising raw juice, primary juice, secondary juice, mixed juice, sulphited juice, limed juice, decanted juice, clear juice, floated juice, clarified juice, raw sugar solution, and/or VHP, VVHP, crystal, white sugar solution.
[4] The method according to any of the paragraphs 1-3, wherein the oxidoreductase is selected from oxidases or dehydrogenases.
[5] The method according to paragraph 4, wherein the oxidases are selected from the group consisting of glucose oxidase (EC 1.1.3.4), or carbohydrate oxidases (EC 1.1.3).
[6] The method according to paragraph 4, wherein the dehydrogenase is selected from the group consisting of glucose dehydrogenase (EC 1.1.99.10), cellobiose dehydrogenase (EC 1.1.99.18), glucooligosaccharide oxidase (EC 1.1.99.B3) or other suitable carbohydrate dehydrogenases (EC 1.1.99).
[7] The method according to any of the preceding paragraphs, wherein at least 20%, at least 25%, at least 30%, at least 35%, particularly at least 40%, more particularly 45%, even more particularly at least 50% of the color is removed.
[8] The method according to any of the preceding paragraphs, wherein the color reduction is obtainable when the glucose oxidase, carbohydrate oxidase, or dehydrogenase is added at any step before evaporation in a sugar production process.
[9] The method according to any of the preceding paragraphs, wherein reduction in color is obtained by removal of color which is not a melanoidin.
[10] The method according to paragraph 5, wherein the glucose oxidase is an Aspergillus niger glucose oxidase, and preferably the oxidase disclosed as the mature polypeptide of SEQ ID NO: 2, particularly amino acids 17-605 of SEQ ID NO: 2 or a polypeptide having a sequence identity to amino acids 17-605 of SEQ ID NO: 2 of at least 85%, at least 90%, at least 91%, at least 92%, at least 93%, at least 94%, at least 95%, at least 96%, at least 97%, at least 98%, at least 99%, or 100%, which have glucose oxidase activity.
[11] The method according to paragraph 5, wherein the glucose oxidase is an Acremonium strictum carbohydrate oxidase, and more particularly the oxidase disclosed as the mature polypeptide of SEQ ID NO: 4, particularly amino acids 20-499 of SEQ ID NO: 4 or a polypeptide having a sequence identity to amino acids 20-499 of SEQ ID NO: 4 of at least 85%, at least 90%, at least 91%, at least 92%, at least 93%, at least 94%, at least 95%, at least 96%, at least 97%, at least 98%, at least 99%, or 100%, which have carbohydrate oxidase activity.
[12] The method according to paragraph 6, wherein the dehydrogenase is selected from the group consisting of Humicula insolens cellobiose dehydrogenase, particularly the cellobiose dehydrogenase disclosed as the mature cellobiose dehydrogenase of SEQ ID NO: 6, particularly amino acids 24-785 of SEQ ID NO: 6, or a polypeptide having a sequence identity to amino acids 24-785 of SEQ ID NO: 6 of at least 85%, at least 90%, at least 91%, at least 92%, at least 93%, at least 94%, at least 95%, at least 96%, at least 97%, at least 98%, at least 99%, or 100%, which have cellobiose dehydrogenase activity.
[13] The method according to paragraph 6, wherein the dehydrogenase is selected from the group consisting of Myceliopthora thermophile cellobiose dehydrogenase, particularly the cellobiose dehydrogenase disclosed as the mature cellobiose dehydrogenase of SEQ ID NO: 8, particularly amino acids 22-828 of SEQ ID NO: 8, or a polypeptide having a sequence identity to amino acids 22-828 of SEQ ID NO: 8 of at least 85%, at least 90%, at least 91%, at least 92%, at least 93%, at least 94%, at least 95%, at least 96%, at least 97%, at least 98%, at least 99%, or 100%, which have cellobiose dehydrogenase activity.
[14] The method according to paragraph 6, wherein the dehydrogenase is selected from the group consisting of Glomerella cingulata glucose dehydrogenase, particularly the glucose dehydrogenase disclosed as the mature glucose dehydrogenase of SEQ ID NO: 10, particularly amino acids 17-600 of SEQ ID NO: 10, or a polypeptide having a sequence identity to amino acids 17-600 of SEQ ID NO: 10 of at least 85%, at least 90%, at least 91%, at least 92%, at least 93%, at least 94%, at least 95%, at least 96%, at least 97%, at least 98%, at least 99%, or 100%, which have glucose dehydrogenase activity.
[15] The method according to any of the preceding paragraphs, wherein the enzymatically produced hydrogen peroxide is insufficient to result in an equivalent reduction in color and/or turbidity.
[16] The method according to any of the preceding paragraphs, wherein the pH during enzymatic treatment is in the range from 3-7.
[17] A method for decolorizing a fruit juice or fruit juice concentrate, wherein the fruit juice or fruit juice concentrate is treated enzymatically with an oxidoreductase resulting in a decrease in color of the fruit juice or fruit juice concentrate.
[18] The method according to paragraph 17, wherein the fruit juice or fruit juice concentrate is obtained from apple, pear, pineapple or papaya.
[19] The method according to any of the paragraphs 17-18, wherein the oxidoreductase is selected from oxidases.
[20] The method according to paragraph 19, wherein oxidases are selected from the group consisting of glucose oxidase (EC 1.1.3.4), or other suitable carbohydrate oxidases (EC 1.1.3).
[21] The method according to paragraph 20, wherein the glucose oxidase is an Aspergillus niger glucose oxidase, and preferably the oxidase disclosed as the mature polypeptide of SEQ ID NO: 2, particularly amino acids 17-605 of SEQ ID NO: 2 or a polypeptide having a sequence identity to amino acids 17-605 of SEQ ID NO: 2 of at least 85%, at least 90%, at least 91%, at least 92%, at least 93%, at least 94%, at least 95%, at least 96%, at least 97%, at least 98%, at least 99%, or 100%, which have glucose oxidase activity.
[22] The method according to paragraph 20, wherein the glucose oxidase is an Acremonium strictum carbohydrate oxidase, and more particularly the oxidase disclosed as the mature polypeptide of SEQ ID NO: 4, particularly amino acids 20-499 of SEQ ID NO: 4 or a polypeptide having a sequence identity to amino acids 20-499 of SEQ ID NO: 4 of at least 85%, at least 90%, at least 91%, at least 92%, at least 93%, at least 94%, at least 95%, at least 96%, at least 97%, at least 98%, at least 99%, or 100%, which have carbohydrate oxidase activity.
[23] The method according to paragraph 20, wherein the carbohydrate oxidase is from Microdochium nivale.
[24] The method according to any of the paragraphs 17-23, wherein a separation step is included after enzymatic treatment in order to remove color precipitate.
[25] The method according to paragraph 24, wherein the separation step is filtration.
[26] A method for preventing color formation during cold storage of fruit juice concentrate, wherein the fruit juice concentrate is treated enzymatically with an oxidoreductase.
[27] The method according to paragraph 26, wherein the fruit juice concentrate is apple juice concentrate.
[28] The method according to paragraph 26, wherein the oxidoreductase is an Aspergillus niger glucose oxidase, and preferably the oxidase disclosed as the mature polypeptide of SEQ ID NO: 2, particularly amino acids 17-605 of SEQ ID NO: 2 or a polypeptide having a sequence identity to amino acids 17-605 of SEQ ID NO: 2 of at least 85%, at least 90%, at least 91%, at least 92%, at least 93%, at least 94%, at least 95%, at least 96%, at least 97%, at least 98%, at least 99%, or 100%, which have glucose oxidase activity.
[29] The method according to paragraph 26, wherein the glucose oxidase is an Acremonium strictum carbohydrate oxidase, and more particularly the oxidase disclosed as the mature polypeptide of SEQ ID NO: 4, particularly amino acids 20-499 of SEQ ID NO: 4 or a polypeptide having a sequence identity to amino acids 20-499 of SEQ ID NO: 4 of at least 85%, at least 90%, at least 91%, at least 92%, at least 93%, at least 94%, at least 95%, at least 96%, at least 97%, at least 98%, at least 99%, or 100%, which have carbohydrate oxidase activity.
[30] The method according to paragraph 26, wherein the carbohydrate oxidase is from Microdochium nivale.
[31] The method according to any of the paragraphs 17-28, wherein the reduction in color is obtained by removal of color which is not a melanoidin.

### EXAMPLES

### Methods

### Glucose Oxidase Activity

Glucose oxidase activity is measured in GODUF.
1 glucose oxidase FIA unit (GODUF) is the amount of enzyme which produces 1 μmol hydrogen peroxide per minute under the standard conditions.
Glucose oxidase (β-D-glucose: oxygen-1-oxidoreductase, EC 1.1.3.4) oxidizes β-D-glucose in the presence of oxygen to form gluconolactone and hydrogen peroxide. This hydrogen peroxide oxidizes ABTS-R (2,2′-azino-di[3-ethylbenzthiazoline-6-sulphonate]) in the presence of peroxidase. This generates a blue-green color which is measured using a photometer at 418 nm.

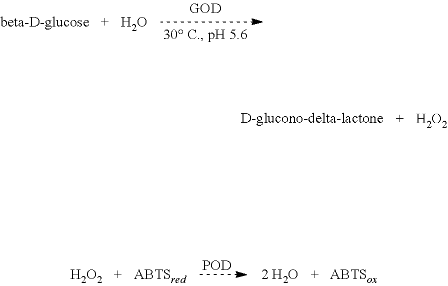

Reaction Conditions:

Substrate: Glucose, 15.3 g/l, 90 mM

Buffer: Acetate, 0.1 M

pH: 5.6±0.05

Incubation temperature: 30° C.±1

Reaction time: 34 seconds

### Color and Turbidity Determinations According to the ICUMSA Standards

Color is measured as the total effect of all colorants on light absorbance due to the complexity and hard quantification of compounds. Turbidity is designated by the turbidity index, a measurement of absorbance due to suspended solids in juices and syrups.

### Equipment and Reagents

Ultrasonic bath (or vacuum pump); Spectrophotometer; pHmeter (0.01 pH); Refractometer; Membrane filter holders; Analythical balance.
Kieselguhr (or Celite); Distilled water; Hydrochloric acid (0.1M); Sodium hydroxide (0.1M); Membrane filters (0.45 μm); Spectrophotometer Cells (cell length of 1.0 cm is recommended);

### Procedure

### Sample Preparation.

The sugar sample to be tested is dissolved in distilled water (in order to measure turbidity, the water must be filtered through a 0.45 μm membrane filter). The following concentrations can be used:
In case of white sugars, use 50 g of sample per 50 g of distilled water (dissolve the sugar by swirling at room temperature);
In case of Darker-colored sugars, use concentrations as high as practicable, consistent with reasonable filtration rates and cell depths;
In case of liquor, syrups, and juices, dilute to 50% solids or original density, unless dilution is required to obtain reasonable filtration rates or cell depths (or to be at the preferred range of 20-80% transmittance). It is recommended that syrups are diluted to 25±2° Br for turbidity measurement (no dilution is needed in case of clarified juices).

Measure and record the pH of sample to the nearest 0.01 pH unit. Two fractions should be considered: a volume suitable for the measurement of turbidity and other fraction used for the measurement of color.

### Determination of Parameters

### Color Measurement

The pH of sugar solution is adjusted to 7.0±0.1 with 0.1 M hydrochloric acid or 0.1 M sodium hydroxide (use a fine dropper). The solution is filtered through a membrane filter, pore size 0.45 μm. Slower-filtering solutions are filtered with Kieselguhr (1% on sugar mass) through filter paper. If Kieselguhr is used, the first portion of the filtrate is discarded if cloudy. Air is removed under vacuum (1 hour at room temperature) or in an ultrasonic bath (3 min), care being taken to minimize evaporation. The density and RDS of solution is measured after de-aerating.

The absorbancy of the solution is determined at 420 nm using filtered distilled water as the reference standard for zero color (The solution concentration and the cell length are chosen so that the instrument reading will be between 0.2 and 0.8 transmittance. For solutions of white sugar, the cell length should be as long as possible).

$$IU = \frac{{A}_{420} {10}^{8}}{δ RDS ρ}$$

IU—ICUMSA color. Unit: IU₇₀ (ICUMSA color unit);

A₄₂₀—absorbance at 420 nm;

δ—cell length (cm);

RDS—refractometric dry substance of the solution (° Brix)

ρ—density of the solution, (kg/m³);

### Turbidity Measurement.

In order to measure the turbidity of the test solution (neither filtered or pH adjusted volume fraction), one must select the absorbance to 900 nm and then use the following expression [3],

$$Turbidity = \frac{{A}_{900} 100}{δ}$$

where A₉₀₀=absorbance at 900 nm.

### REFERENCES

[1] ICUMSA Book, Reference: ICUMSA GS1/3-7 (2011), Determination of the Solution of Raw Sugars, Brown Sugars and Coloured Syrups at pH 7.0—Official.
[2] ICUMSA Book, Reference: ICUMSA GS2/3-10 (2011), The Determination of White Sugar Solution Colour—Official.
[3] ICUMSA Book, Reference: ICUMSA GS7-21 (207), The Determination of Turbidity in clarified cane juice, Syrups and Clarified Syrups—Accepted.

### Example 1

### Enzymes Used in the Invention

The present invention have been illustrated using examples of representative oxidoreductase enzymes

Glucose oxidase (GOX) activity of the invention is measured in GODUF units as described above.

Glucose Oxidase from Aspergillus niger

Glucose oxidase is commercially produced by Novozymes A/S under the trade name Gluzyme Mono 10.000BG (Novozymes A/S, Bagsværd, Denmark). The enzyme (SEQ ID NO: 2) used in examples 1-7 was a purified form of Gluzyme Mono derived from an industrial strain of Aspergillus oryzae in which the Aspergillus niger glucose oxidase gene (SEQ ID NO: 1) was introduced.

The start material was approximately pH 4.5 and the conductivity was 20 mS/cm. The start material also contains some catalase activity. During the purification procedure, the glucose oxidase could easily be separated from catalase due to the visual properties of the proteins; glucose oxidase is yellow and catalase is green.

The frozen start material was thawed and the pH was adjusted to pH 5.0 with 3M Tris-base with stirring of the solution. To reduce the conductivity of the solution it was ultrafiltered on 10 kDa cut-off membranes and washed with deionized water to reach a conductivity of 0.5 mS/cm. The diawashed solution was applied to a Q-sepharose FF column (from GE Healthcare) equilibrated in 20 mM CH3COOH/NaOH, pH 5.0. After washing the column with the equilibration buffer, the column was eluted with a linear NaCl gradient (0-0.5M) over 3 column volumes. Fractions were collected during elution. Yellow fractions were pooled and solid (NH4)2SO4 was added to a final 2.0M (NH4)2SO4 concentration. The yellow pool was applied to a Phenyl-sepharose FF high substitution column (from GE Healthcare) equilibrated in 20 mM succinic acid/NaOH, 2M (NH4)2SO4, pH 6.0. After washing the column with the equilibration buffer the column was eluted with a linear (NH4)2SO4 gradient (2.0-0M) over 3 column volumes. Fractions were collected during elution and bright yellow fractions were pooled. To reduce the conductivity of the solution it was ultra-filtered on 10 kDa cut-off membranes and diawashed with deionized water to reach a conductivity of 0.5 mS/cm. The glucose oxidase pool was washed extensively with 20 mM CH3COOH/NaOH, 150 mM NaCl, pH 6 on 10 kDa cut-off membrane. The resulting glucose oxidase was the product of the purification. The activity of the purified preparation was 5360 GODUF/g and catalase activity was below detection limits (852 CIU/g).

Carbohydrate Oxidase (COX) from Acremonium strictum.

Sarocladium (Acremonium) strictum glucooligosaccharide oxidase (AsCOx, SEQ ID NO:4) was described in “M. H. Lee, W.-L. Lai, S.-F. Lin, C.-S. Hsu, S.-H. Liaw, Y.-C. Tsai, Appl. Environ. Microbiol., 2005, 71, 8881-8887” (UNIPROT:Q6PW77). The polynucleotide encoding the AsCOX is disclosed herein as SEQ ID NO: 3.

Scytalidium thermophilum Catalase

Recombinantly produced Scytalidium thermophilum catalase is described in U.S. Pat. No. 5,646,025. The catalase has a typical activity of 220000 CIU/g. One CIU will degrade one μmol H₂O₂ per minute at pH 7.0 and 25° C., reducing the H₂O₂ concentration from 10.3 to 9.2 mM.

A commercial preparation of Scytalidium thermophilum catalase, Catazyme, was obtained from Novozymes Bagsvaerd, Denmark. 50 ml of the preparation was dialyzed against milli-Q water and then 10 mM phosphate buffer pH 7. The sample was concentrated by UF (10 kDa cut-off) to 10 ml, filtered through a 0.45 μm membrane. 5 ml of this sample was applied on a HiLoad (26/60) Superdex 200 column with 20 mM phosphate buffer pH 7. Catalase fractions were pooled and stored in the freezer.

### Cloning and Expression of Cellobiose Dehydrogenases and Glucose Dehydrogenase

The genes (SEQ ID NO: 5, 7, and 9) encoding the described dehydrogenase enzymes (SEQ ID NO: 6, 8 and 10) were cloned into an expression plasmid pEN12516 following traditional cloning methods (Sambrook et al., Molecular Cloning: A Laboratory Manual, 2nd Ed., Cold Spring Harbor, 1989). Plasmid pENI2516 was described in WO 2004/069872 Example 2. The plasmids were transformed in Aspergillus oryzae strain ToC1512 for enzyme expression and fermented using standard methods. Aspergillus oryzae strain ToC1512 was described in WO 2005/070962, Example 11. The enzymes were purified by standard protein chromatography methods, including hydrophobic interaction and ion-exchange chromatography steps.

Expression and purification of Humicola insolens cellobiose dehydrogenase, HiCDH (SEQ ID NO: 6):

The identification of HiCDH, recombinant expression and purification of the enzyme are described in U.S. Pat. No. 6,033,891 and U.S. Pat. No. 6,280,976.

Expression and purification of Myceliophthora thermophila cellobiose dehydrogenase, MtCDH (SEQ ID NO: 8):

The cloning and characterization of MtCDH is described Subramaniam et al., 1999 [not a complete reference] The enzyme was expressed and purified using methods known in the art.

Expression and purification of Glomerella cingulata glucose dehydrogenase, GcGDH (SEQ ID NO: 10)

The DNA sequence for GcGDH was reported in: Sygmund C., Klausberger M., Felice A. K., Ludwig R.; Reduction of quinones and phenoxy radicals by extracellular glucose dehydrogenase from Glomerella cingulata suggests a role in plant pathogenicity.; Microbiology 157:3203-3212(2011).

The DNA information used for cloning is available in the EMBL database: (EMBL:JF731352) and the protein sequence under SWISSPROT: G8E4B5.

### Example 2

### Use of Glucose Oxidase for Treatment of Sugar Cane Primary Juice, Mixed Sugar Cane Juice and Raw Sugar Solution

Chemicals: The filter aid Celite, Distilled water, hydrochloric acid, sodium hydroxide were obtained from Sigma chemicals.
Enzymes: Experimental Glucose Oxidase (GOX) described in Example 1; Scytalidium catalase from Example 1.
Membrane filters (PVDF, 25 mm diameter, pore size 0.45 μm); Glass fiber filter, microplate reader Eon from Biotek
20 GODUF/mL were added 10 mls of the sugar cane primary juice, sugar cane mixed juice and raw sugar solution (30° Bx) under the following conditions:

All tubes are placed in a rotary shaker at 25 RPM and 40° C. for 6 hours. The enzyme reactions were terminated by heat inactivation in a boiling in water bath for 15 minutes, followed by 5 min in ice bath.

For the decanted juice, half of the sample (5 mls) was heat treated to inactivate the enzymes while the other half was not heat treated. The tubes were then centrifuged at 4000 rpm for 5 min. The pH of the decanted solution was measured and an aliquot of the supernatant was used to measure the final color. Samples were kept frozen overnight until measurement in the next day.

Determination of color in the enzymatically treated samples:

The method is adapted from ICUMSA method (ICUMSA, Reference: ICUMSA GS1/7, Method for Color Measurement).

Samples are diluted as many times as necessary to have transmittance in the range of 20% to 80%. The pH was then adjusted to 7.0±0.1 with diluted sodium hydroxide and hydrochloric acid, and then filtered through 0.45 μm of PVDF filter membrane.

Absorbance was read at 420 nm in a microplate spectrophotometer in a 96-well flat bottom plate, using 300 uL of solution.

### REFERENCES

ICUMSA, Reference: ICUMSA GS1/7, Method for Color Measurement.
REIN, P. Cane Sugar Engineering, Bartens, 1o Edition, Berlin, 2007.

### Example 3

### Enzymatic Removal of Color from Sugarcane Juice with A. niger Glucose Oxidase, AnGOX

In this example, mixed juice samples derived from a milling tandem are considered. Hence, 1% diatomaceous filter aid (CAS 68855-54-9; Manufacturer: CELITE CHILE S.A.-WORLD MINERALSCellite) was added to the sugarcane juice to aid in the filtration. The mixture was then filtered through a vacuum filtration device with a glass filter to eliminate the suspended solids. The filtered samples were transferred to Falcon 50 mls conical tubes. To each assay tube containing 10 mL of juice, a dose of 400 U/(mL juice) of AnGOX was added. The tubes were incubated at 40° C. under shaking conditions (75 rpm) for at least 6 hours. After the six hour incubation, each sample was divided in two portions and then, one portion was submitted to an inactivation treatment in boiling water as in Example 2. All samples were centrifuged, diluted to 5 times, pH adjusted to 7 (+/−0.1), filtered with 0.45 micron PVDF membrane, and measured for absorbance at 420 nm in spectrophotometer. For the purpose of the lab scale test, the absorbance measured will correspond to a color measurement, since other parameters normally considered in ICUMSA color values (IU_{7.0}) such as density, concentration, cell size are assumed to be constant.

The juice used in the sample had an initial pH of 5.3. Before the inactivation treatment and without pH adjustment, a color reduction of 28% was observed in AnGOX enzyme treated samples. The similar color reduction (25%) was observed if the samples were heat inactivated to destroy enzyme activity as described above. When the juice samples were pH adjusted to 7 before enzyme addition, a color reduction of 31% was observed. Two assays are shown in Table 1, identified as Exp#1 and Exp#2 (a different sample of mixed juice was used at each experiment, i.e., collected at different period of time at the Mill).

TABLE 1
Percentage of color reduction in mixed juice after enzymatic
treatment with AnGOX. Exp#1 and Exp#2 correspond
to different assay using distinct mixed juice samples.

| | | Heat | % color reduction | |
|---|---|---|---|---|
| Sample | pH | inactivation | Exp#1 | Exp#2 |
| untreated mixed juice | 5.3 | No | 0 | 0 |
| juice added GOX | Nd | No | 28.80% | 17.48% |
| juice added GOX | Nd | Yes | 15.32% | 25.09% |
| juice added GOX | 7.0 | No | 23.11% | 23.13% |
| juice added GOX | 7.0 | Yes | 16.85% | 31.89% |

### Example 4

### Decolorization of Decanted Sugarcane Juice

Decanted juice consists of a sample collected after a clarification treatment. In the clarification treatment in traditional Sugarcane Mills, the juice is cleaned using slaked lime (defecation process) and sulphur dioxide (sulfitation). This treatment settles much of the soil and a large amount of colorant, fats, waxes and proteins. The value of pH is also corrected to around pH7 after completion of the clarification process. Demonstration of the effect of glucose oxidase on this type of sample is important because the clarification process is well suited for initial removal of impurities and removal of remaining color and turbidity is important for further downstream sugar refining.

The juice samples are submitted to the enzymatic treatment as described in example 2. Then, samples were centrifuged, diluted to 5 times, pH adjusted to 7 (+/−0.1), filtered with 0.45 micron PVDF membrane, and measured for absorbance at 420 nm in spectrophotometer. The initial pH of samples was around 6.8.

At pH 6.8, a color reduction of 27% and 36% was observed in AnGOX enzyme treated samples before and after the enzyme inactivation, respectively. When the juice samples were pH adjusted to 7 before enzyme addition, a color reduction of 36% was observed. Two assays are shown in Table 2, identified as Exp#1 and Exp#2 (a different sample of decanted juice was used at each experiment, i.e., collected at different period of time at the Mill).

TABLE 2
Percentage of color reduction in decanted juice after enzymatic
treatment with AnGOX. Exp#1 and Exp#2 correspond
to different assay using distinct decanted juice samples.

| | | Heat | % color reduction | |
|---|---|---|---|---|
| Sample | pH | inactivation | Exp#1 | Exp#2 |
| untreated decanted juice | 6.8 | No | 0 | 0 |
| juice added GOX | Nd | No | 26.55% | 27.01% |
| juice added GOX | Nd | Yes | 36.83% | 28.94% |
| juice added GOX | 7.0 | No | 30.36% | 26.73% |
| juice added GOX | 7.0 | Yes | 36.27% | 34.06% |

### Example 5

### Decolorization of Dissolved Sugar Cane Raw Sugar (VHP Sugar Solution)

Raw sugar was diluted with distilled water to 30° Brix. A part of this solution was enriched with glucose to reach a final concentration of 1% w/w. The pH of both solutions was adjusted to 7.0±0.1, with diluted NaOH. These VHP (very highly polymerized) sugar solutions were vacuum filtered as in example 3. The same procedure and sample volumes were used as in example 3.

Before the inactivation treatment, color reduction of 44% was observed for the case of solutions with 1% w/w glucose). The VHP solution with no glucose addition, color was reduced by 45% after enzyme inactivation.

TABLE 3
Percentage of color reduction in VHP sugar solution after
enzymatic treatment with AnGOX. Exp#1 and Exp#2
correspond to different assay using distinct VHP sugar samples.

| | | Heat | % color reduction | |
|---|---|---|---|---|
| Sample | pH | inactivation | Exp#1 | Exp#2 |
| untreated VHP sugar | 7.0 | No | 0 | 0 |
| solution | | | | |
| VHP Solution added | 7.0 | No | 39.53% | 33.44% |
| GOX | | | | |
| VHP Solution added | 7.0 | Yes | 45.08% | 42.05% |
| GOX | | | | |
| VHP Solution added | 7.0 | No | 44.36% | 30.86% |
| GOX and 1% w/w glucose | | | | |
| VHP Solution added | 7.0 | Yes | 47.15% | 39.61% |
| GOX and 1% w/w glucose | | | | |

### Example 6

### Dose Response of Glucose Oxidase on the VHP Sugar Solution for Decolorization

The substrates tested were VHP sugar solution (30° Brix) and decanted sugarcane juice as in the above experiment. The doses of 5, 15, 20 and 40 GODUF/mL were used and the percentages of reduction were listed in Table 4. Significant color reduction was already achieved with 5 GODUF/mL (up to 27% for the case of VHP sugar solution).

TABLE 4
Percentages of color reduction in VHP
sugar solution and decanted juice.

| Dose | VHP Sugar solution 30° Brix | | Decanted Juice | |
|---|---|---|---|---|
| (GODUF/ | Before in- | After in- | Before in- | After in- |
| mL | activation | activation | activation | activation |
| substrate) | % Reduction | % Reduction | % Reduction | % Reduction |
| 0 | — | — | — | — |
| 5 | 18.83% | 27.73% | 26.20% | 25.24% |
| 15 | 26.01% | 42.97% | 33.72% | 33.33% |
| 20 | 26.01% | 41.02% | 34.49% | 35.26% |
| 40 | 33.18% | 47.66% | 33.33% | 37.19% |

### Example 7

### Kinetic Response of Glucose Oxidase on Sugarcane Substrates for Decolorization

Samples were incubated with 20 GODUF/ml dose at 40° C. for 5 hours at 25 rpm (with heat inactivation at the end of reaction—100° C. for 15 min). Adjustment of pH is only carried out at diluted VHP solutions (to pH 7.0). A vacuum filtration with glass filter (using 1% diatomaceous filter aid; Manufacturer: CELITE CHILE S.A.-WORLD MINERALS) is only performed to the juice sample in order to eliminate suspended solids, sand and others. Sampling is performed every hour. All samples were centrifuged, pH adjusted to 7 (+/−0.1), filtered with 0.45 micron PVDF membrane, and measured the absorbance (to have transmittance in the range of 20% to 80%, the juices were diluted 5 times).

The kinetic of the incubation of glucose oxidase (GOx) to decanted juice sample and VHP raw sugar solution results were analyzed. For the case of decanted juice, 60 to 70% of maximum juice decolorization occurs at the first hour of incubation. For the VHP raw sugar, the decolorization rate is linear in range of 5 min to 240 min with 0.054 and 0.078% in reduction per min of incubation for non-inactivated and inactivated samples, respectively. For VHP raw sugar solution, 13% of color reduction is reached for the first hour (case of inactivated samples).

TABLE 5
Percentages of color reduction over incubation
time in decanted juice and VHP sugar

| | Sample: | | | |
|---|---|---|---|---|
| | Decanted juice sample | | VHP sugar (30° Brix) solution | |
| | % Reduction | % Reduction | % Reduction | % Reduction |
| Incubation | After in- | Before in- | After in- | Before in- |
| time (min) | activation | activation | activation | activation |
| 0 | 0 | 0 | 0 | 0 |
| 5 | 4.65 | 12.30 | 5.29 | 4.33 |
| 60 | 24.53 | 20.39 | 13.79 | 6.36 |
| 120 | 28.46 | 25.10 | 24.97 | 14.86 |
| 180 | 30.01 | 26.38 | 30.47 | 19.59 |
| 240 | 34.88 | 27.78 | 36.15 | 23.48 |
| 300 | 33.38 | 31.52 | 35.98 | 29.06 |

### Example 8

### Use of Catalase for Removal of Hydrogen Peroxide Generated from Glucose Oxidase to Sugar Containing Solutions

Catalase (EC 1.11.1.6) was used to remove hydrogen peroxide formed by sugar oxidases as a control experiment. Catalase is an enzyme which catalyzes the decomposition of hydrogen peroxide into water and molecular oxygen. Catelase's catalytic efficiency is among the highest known for any enzyme. Addition of catalase is one way to efficiently remove peroxide that is formed before it can react with other enzymes or substances.

Addition of chemical hydrogen peroxide to sugar solutions has been reported as effective in removing color. In a review on technologies for reducing color in raw sugar, Madho and Davis evaluated hydrogen peroxide treatment as not economically viable. Levels of inclusion of peroxide were from 250 to 7500 ppm. Because, glucose oxidase produces hydrogen peroxide as a bi-product of it oxidation reaction, it is desirable to establish if the color removal effect that we observe in the invention is fully attributable to evolution of peroxide. An experiment was established in which peroxide evolved by the enzymatic activity of AnGOX glucose oxidase on sugar solutions, was rapidly removed by Catalase. Since catalase is very efficient at removing peroxide, if color removal is still observed then another mechanism could be responsible or contribute to the mechanism of color removal.

Sugarcane decanted juice and raw sugar 30° Brix solution (adjusted to pH 7.0±0.1) were placed at incubators for 6 hours at 40° C. and 25 rpm. The enzymatic dose for AnGox was 20 GODUF/mL of solution and for Sc Catalase was 1250 ppm (when added). The reactions were stopped by heat inactivation using boiling in water bath for 15 minutes, followed by 5 min in ice bath. Tubes were centrifuged at 4000 rpm for 5 min. The supernatant were diluted to have transmittance in the range of 20% to 80%. The pH was adjusted to 7.0±0.1, filtered with 0.45 μm of PVDF filtering membrane, and measured the absorbance (420 nm).

Considering these assays with decanted juice and VHP sugar, the color reduction in the presence of catalase was lower, however decolorization is still very significant (19% after 1 hour for VHP and after 3 h for decanted juice). This therefore suggests that color removal cannot be explained by hydrogen peroxide generated by the glucose oxidase.

TABLE 6
Color reduction by GOX with and without catalase addition;
comparison among inactivated samples of VHP sugar solution.

| | | | VHP solution (30° Brix) + | |
|---|---|---|---|---|
| | VHP solution (30° Brix) | | 1% w/w glucose | |
| Incubation | | GOX + | | GOX + |
| time, min | GOX | Catalase | GOX | Catalase |
| 5 | 6.4 | 10.6 | 19.0 | 9.5 |
| 30 | 21.0 | 14.5 | 26.8 | 20.4 |
| 60 | 24.3 | 19.5 | 28.9 | 25.6 |
| 180 | 22.0 | 19.1 | 36.4 | 33.8 |
| 360 | 37.5 | 25.3 | 38.2 | 24.1 |

TABLE 7
Color reduction by GOX with and without catalase addition; comparison
among inactivated/non-activated samples of Decanted juice.

| | |
|---|---|
| Decanted juice | Decanted juice |
| (with inactivation | (with NO inactivation |
| after sampling) | after sampling) |

| Incubation | | GOX + | | GOX + |
|---|---|---|---|---|
| time, min | GOX | catalase | GOX | catalase |
| 60 | 7.7 | 12.8 | 36.7 | 25.0 |
| 120 | 24.3 | 11.6 | Nd | Nd |
| 180 | 28.1 | 19.8 | 31.6 | 21.1 |
| 240 | 16.8 | 18.5 | 33.3 | 24.3 |
| 300 | 29.8 | 18.1 | 25.4 | 17.2 |
| 360 | 29.2 | 18.3 | 31.1 | 26 |

The experiment of bleaching samples of sugarcane raw juices and VHP sugar using the hydrogen peroxide was performed. After incubation period of 30 min at 40° C., the action of H₂O₂ for the color removal of mixed juice, decanted juice and raw sugar solution was determined. All samples were centrifuged, pH adjusted to 7 (+/−0.1), filtered with 0.45 micron PVDF membrane, and measured the absorbance (to have transmittance in the range of 20% to 80%, the juices were diluted 5 times).

The presence of hydrogen peroxide decreased the color (referred as a value of absorbance) of the VHP sugar solution and juices. However, high concentrations of hydrogen peroxide were needed to reach a similar color reduction (>20%) as observed with an enzymatic treatment (use of AnGOx, for example).

TABLE 8
Color reduction of mixed juice, decanted juice and VHP
sugar solution by reaction with hydrogen peroxide.

| | Color reduction | | |
|---|---|---|---|
| Peroxide | VHP sugar | | decanted |
| concentration, | solution | mixed juice | juice |
| % v/v | (30° Brix) | (14.4° Brix) | (17.1° Brix) |
| 0.035% | 8.5% | 2.3% | 3.5% |
| 0.175% | 14.3% | 19.7% | 4.8% |
| 0.35% | 20.0% | 26.8% | 9.4% |
| 0.7% | 29.1% | 35.1% | 13.0% |
| 1.75% | 44.7% | 43.4% | 25.7% |

### Example 9

### Use of Dehydrogenase for Decolorization of Sugar Juice and Sugar Refinery Products

A rapid screen based on a microtiter assay was established identify further examples of oxidoreductases capable of removing color from sugar. The assay enabled the screening of a wide variety of enzymes. The screen was performed in a small scale (96-well format) assay to test the enzyme-based decolorization of raw sugar, and the above oxidoreductases were evaluated, in a buffered solution at pH 7.0.

### Materials

Raw VHP sugar

### Celite 545 (Sigma-Aldrich cat. no. 419931)

MilliQ water
GF/F 125 mm Whatman Glass Microfiber filter (Sigma-Aldrich cat. no. Z242551)
Nalgene 0.2 μm filter (cat. no. 291-4520)
Tris-HCl buffer (100 mM, pH 7.0)
Potassium-phosphate buffer 1 M, pH 7.0

### Protocols

The raw sugar solution was prepared by dissolving 30 g of raw sugar in MilliQ H₂O (30% w/vol, 100 ml), followed by addition of 300 mg of Celite (filtration aid, 1% w/vol of raw sugar) and filtration on a GF/F glass microfiber and a 0.2 μm Nalgene filters. All enzymes were diluted to 10 μM stock solutions, with Tris 100 mM pH 7.0 buffer.

The reaction mixtures were composed of:
20 μl Enzyme solution (10 μM)
160 μl Sugar solution
20 μl potassium-phosphate buffer 1M, pH 7.0
The total reaction volume was 200 μl.
The absorbance at 420 nm was monitored at regular intervals and OD420 values were obtained.

TABLE 9
Sugar decolorization. Decrease in Absorbance at 420 nm (mAU).

| Time/ | | | | | | |
|---|---|---|---|---|---|---|
| hours | No Enzyme | HiCDH | MtCDH | GcGDH | AnGOx | AsCOX |
| 0 | 0 | 0 | 0 | 0 | 0 | 0 |
| 2 | −3 | −2 | −2 | −9 | −9 | −8 |
| 4 | −5 | −6 | −6 | −14 | −17 | −17 |
| 5 | −5 | −7 | −6 | −17 | −20 | −22 |
| 25 | −11 | −20 | −13 | −40 | −36 | −18 |

Table 9: HiCDH (Humicola isolens cellobiose dehydrogenase), MtCDH (Myceliopthora thermophila cellobiose dehydrogenase), GcGDH (Glomeralla cingulata glucose dehydrogenase), AnGOX (Aspergillus niger glucose oxidase), AsCOX (Acremonium strictum carbohydrate oxidase.

As can be observed, in addition to Aspergillus niger glucose oxidase reported in the previous examples as being active in color removal in VHP sugar solutions, a number of other enzymes demonstrate activity. Carbohydrate oxidase, cellobiose dehydrogenase and glucose dehydrogenase demonstrate the ability to remove color similar to the reference enzyme AnGOX (glucose oxidase).

### Example 10

### Decolorization of Apple Juice Using Glucose Oxidase Enzymes

In order to demonstrate the utility of the application of oxidoreductase enzymes in apple juice color management, Aspergillus niger Glucose oxidase described above and disclosed in SEQ ID NO: 2 was applied to experiments to Red Delicious apple juice.

### Preparation of Juice Substrate:

Five kilograms of Red Delicious Apples were used for juice extraction. Red Delicious is known to have a relatively high polyphenol and is one of the prevalent apple types used for juice extraction. The apples were grated and the juice extracted using a Haffico press at 300 bar for 3 minutes. The juice was centrifuged at 5000 rpm for 5 minutes at 25° C. and the clarified juice decanted into a new bottle. The clarified juice was stored at 4 C until use.

### Experiment 1

For the initial screening study 2 mg of the different experimental oxidoreductase enzymes were added to the 30 ml of prepared apple juice in Falcon 50 ml conical tubes. All tubes were maintained with the following incubation conditions, 37° C. at 200 rpm. The absorbance measured at 420 nm after 1, 2 and 36 hours of incubation with a standard spectrophotometer.

### Determination of Color in Enzymatically Treated Juice Sample:

After the enzymatic treatment, the juice samples were centrifuged again at 5000 rpm for 10 min and the centrifugate decanted to a new tube.

The absorbance was measured using Molecular Device reader at 420 nm

| Sample | Dosage | Abs | % color reduction |
|---|---|---|---|
| Control | 0 | 0.697 | 0 |
| AnGOX | 2.0 | 0.277 | 60 |

Dosage: enzyme protein (mg) per 30 ml of juice
Abs: Absorbance at 420 nm after 36 hour after centrifugation
% color reduction, negative values indicate increase in color.

Glucose oxidase treated apple juice shows 60% reduction in color after the colored precipitate was removed by centrifugation. Further studies have shown that the precipitation of color into particle sizes large enough to remove by centrifugation, also enables a simple filtration step to remove the particles. Such a filtration step is standard in the production of AJC.

### Experiment 2

### Percentage Color Reduction in the Red Delicious Apple Juice (Incubation 37° C./4 Hrs/200 rpm)

For the dose optimization study 30 ml of juice in 50 ml Falcon conical tubes were treated with different dosages of enzymes under the following conditions: 37° C. at 200 rpm for 4 hours. After the enzymatic treatment, the juice samples were centrifuged again at 5000 rpm for 10 min and the filtrate decanted into fresh Falcon 50 ml tubes. The absorbance was then measured using Molecular Device reader at 420 nm.

| Sample | Dosage | | Abs | % color reduction |
|---|---|---|---|---|
| control | 0 | 0 | 0.68 | 0% |
| GOX | 100 | 0.53 | 0.66 | 3% |
| GOX | 250 | 1.34 | 0.60 | 12% |
| GOX | 500 | 2.68 | 0.57 | 16% |
| GOX | 1000 | 5.36 | 0.51 | 25% |

Dosage: enzyme protein as parts per million (ppm)
Abs: Absorbance at 420 nm after 4 hours and after centrifugation
% color reduction: Positive value represents a reduction in color in the juice after centrifugation.

Significant visual difference was observed in color removal of apple juice at 250, 500 and 1000 ppm of glucose oxidase (SEQ ID NO: 2). 16% and 25% reduction in colour is observed in 500 ppm and 1000 ppm treated juice samples.

### Example 11

### Decolourization of Apple Juice Using Carbohydrate Oxidase Enzymes

Granny Smith is a green apple but is known to have a relatively high polyphenol and is one of the prevalent apple types used for juice extraction. Five kilograms of Granny Smith apples were used for juice extraction. The apples were grated and a carbohydrate oxidase enzyme from Microdochium nivale was added to the grated apple material directly. Incubation proceeded at 23 degrees centigrade for 1 hour. The juice was then extracted using a Haffico press at 300 bar for 3 minutes. The extracted juice was then pasteurized and filtered through Watman no. 1 paper filter paper. The filtered juice was then analyzed. Color differences were studied using absorbance was measured at 420 nm. Total polyphenol content was measured using Folin-Ciocalteu colorimetric method (FC method).

Enzyme details: The carbohydrate oxidase enzyme from Microdochium nivale is described in Xu F, et. al., Eur J Biochem. 2001 February; 268(4):1136-42 and in WO99/31990.

| Enzyme | activityProtein | Concentration (mg/ml) |
|---|---|---|
| Carbohydrate oxidase | 600 COXU/ml | 6.2 |

| Sample | Control | COX |
|---|---|---|
| Color (OD at 420 nm) | 0.226 | 0.158 |
| Polyphenol (OD at 765 nm | 0.85 | 0.27 |
| using FC method) | | |
| stdev | 0.06 | 0.03 |

As can be seen, a significant reduction of color is observed in the carbohydrate oxidase treated sample (30%). The polyphenol content also has been reduced by 68%.

1. A method for decolorizing a sugar solution obtained from sugar crops, wherein the solution is treated enzymatically with a glucose oxidase (EC 1.1.3.4), carbohydrate oxidases (EC 1.1.3) or a dehydrogenase resulting in a decrease in color and/or turbidity of the solution.

2. The method according to claim 1, wherein at least 20%, at least 25%, at least 30%, at least 35%, particularly at least 40%, more particularly 45%, even more particularly at least 50% of the color is removed.

3. The method according to claim 1, wherein the color reduction is obtainable when the glucose oxidase, carbohydrate oxidase, or dehydrogenase is added at any step before evaporation in a sugar production process.

4. The method according to claim 1, wherein reduction in color is obtained by removal of color which is not a melanoidin.

5. The method according to claim 1, wherein the sugar solution is obtained from any sucrose containing sugar crops, such as, sugar cane, sugar beet, sweet sorghum.

6. The method according to claim 1, wherein the sugar solution is selected from the group comprising raw juice, primary juice, secondary juice, mixed juice, sulphited juice, limed juice, decanted juice, clear juice, floated juice, clarified juice, raw sugar solution, and/or VHP, VVHP, crystal, white sugar solution.

7. The method according to claim 1, wherein the glucose oxidase is an Aspergillus niger glucose oxidase, and preferably the oxidase disclosed as the mature polypeptide of SEQ ID NO: 2, particularly amino acids 17-605 of SEQ ID NO: 2 or a polypeptide having a sequence identity to amino acids 17-605 of SEQ ID NO: 2 of at least 85%, at least 90%, at least 91%, at least 92%, at least 93%, at least 94%, at least 95%, at least 96%, at least 97%, at least 98%, at least 99%, or 100%, which have glucose oxidase activity.

8. The method according to claim 1, wherein the carbohydrate oxidase is an Acremonium strictum carbohydrate oxidase, and more particularly the oxidase disclosed as the mature polypeptide of SEQ ID NO: 4, particularly amino acids 20-499 of SEQ ID NO: 4 or a polypeptide having a sequence identity to amino acids 20-499 of SEQ ID NO: 4 of at least 85%, at least 90%, at least 91%, at least 92%, at least 93%, at least 94%, at least 95%, at least 96%, at least 97%, at least 98%, at least 99%, or 100%, which have carbohydrate oxidase activity.

9. The method according to claim 1, wherein the dehydrogenase is selected from the group consisting of glucose dehydrogenase (EC 1.1.99.10), cellobiose dehydrogenase (EC 1.1.99.18), glucooligosaccharide oxidase (EC 1.1.99.B3) or other suitable carbohydrate dehydrogenases (EC 1.1.99).

10. The method according to claim 9, wherein the dehydrogenase is selected from the group consisting of Humicula insolens cellobiose dehydrogenase, particularly the cellobiose dehydrogenase disclosed as the mature cellobiose dehydrogenase of SEQ ID NO: 6, particularly amino acids 24-785 of SEQ ID NO: 6, or a polypeptide having a sequence identity to amino acids 24-785 of SEQ ID NO: 6 of at least 85%, at least 90%, at least 91%, at least 92%, at least 93%, at least 94%, at least 95%, at least 96%, at least 97%, at least 98%, at least 99%, or 100%, which have cellobiose dehydrogenase activity.

11. The method according to claim 9, wherein the dehydrogenase is selected from the group consisting of Myceliopthora thermophile cellobiose dehydrogenase, particularly the cellobiose dehydrogenase disclosed as the mature cellobiose dehydrogenase of SEQ ID NO: 8, particularly amino acids 22-828 of SEQ ID NO: 8, or a polypeptide having a sequence identity to amino acids 22-828 of SEQ ID NO: 8 of at least 85%, at least 90%, at least 91%, at least 92%, at least 93%, at least 94%, at least 95%, at least 96%, at least 97%, at least 98%, at least 99%, or 100%, which have cellobiose dehydrogenase activity.

12. The method according to claim 9, wherein the dehydrogenase is selected from the group consisting of Glomerella cingulata glucose dehydrogenase, particularly the glucose dehydrogenase disclosed as the mature glucose dehydrogenase of SEQ ID NO: 10, particularly amino acids 17-600 of SEQ ID NO: 10, or a polypeptide having a sequence identity to amino acids 17-600 of SEQ ID NO: 10 of at least 85%, at least 90%, at least 91%, at least 92%, at least 93%, at least 94%, at least 95%, at least 96%, at least 97%, at least 98%, at least 99%, or 100%, which have glucose dehydrogenase activity.

13. The method according to claim 1, wherein the enzymatically produced hydrogen peroxide is insufficient to result in an equivalent reduction in color and/or turbidity.

14. The method according to claim 1, wherein the pH during enzymatic treatment is in the range from 3-7.

15. A method for decolorizing a fruit juice or fruit juice concentrate, wherein the fruit juice or fruit juice concentrate is treated enzymatically with glucose oxidase (EC 1.1.3.4), or other suitable carbohydrate oxidases (EC 1.1.3) resulting in a decrease in color of the fruit juice or fruit juice concentrate.

16. The method according to claim 15, wherein the fruit juice or fruit juice concentrate is obtained from apple, pear, pineapple or papaya.

17. The method according to claim 15, wherein the glucose oxidase is an Aspergillus niger glucose oxidase, and preferably the oxidase disclosed as the mature polypeptide of SEQ ID NO: 2, particularly amino acids 17-605 of SEQ ID NO: 2 or a polypeptide having a sequence identity to amino acids 17-605 of SEQ ID NO: 2 of at least 85%, at least 90%, at least 91%, at least 92%, at least 93%, at least 94%, at least 95%, at least 96%, at least 97%, at least 98%, at least 99%, or 100%, which have glucose oxidase activity.

18. The method according to claim 15, wherein the carbohydrate oxidase is an Acremonium strictum carbohydrate oxidase, and more particularly the oxidase disclosed as the mature polypeptide of SEQ ID NO: 4, particularly amino acids 20-499 of SEQ ID NO: 4 or a polypeptide having a sequence identity to amino acids 20-499 of SEQ ID NO: 4 of at least 85%, at least 90%, at least 91%, at least 92%, at least 93%, at least 94%, at least 95%, at least 96%, at least 97%, at least 98%, at least 99%, or 100%, which have carbohydrate oxidase activity.

19. The method according to claim 15, wherein the carbohydrate oxidase is from Microdochium nivale.

20. The method according to claim 15, wherein a separation step is included after enzymatic treatment in order to remove color precipitate.

21. The method according to claim 20, wherein the separation step is filtration.

22. A method for preventing color formation during cold storage of fruit juice concentrate, wherein the fruit juice concentrate is treated enzymatically with glucose oxidase (EC 1.1.3.4), or other suitable carbohydrate oxidases (EC 1.1.3).

23. The method according to claim 22, wherein the fruit juice concentrate is apple juice concentrate.

24. The method according to claim 22, wherein the glucose oxidoreductase is an Aspergillus niger glucose oxidase, and preferably the oxidase disclosed as the mature polypeptide of SEQ ID NO: 2, particularly amino acids 17-605 of SEQ ID NO: 2 or a polypeptide having a sequence identity to amino acids 17-605 of SEQ ID NO: 2 of at least 85%, at least 90%, at least 91%, at least 92%, at least 93%, at least 94%, at least 95%, at least 96%, at least 97%, at least 98%, at least 99%, or 100%, which have glucose oxidase activity.

25. The method according to claim 22, wherein the carbohydrate oxidase is from Microdochium nivale.

26. The method according to claim 22, wherein the carbohydrate oxidase is an Acremonium strictum carbohydrate oxidase, and more particularly the oxidase disclosed as the mature polypeptide of SEQ ID NO: 4, particularly amino acids 20-499 of SEQ ID NO: 4 or a polypeptide having a sequence identity to amino acids 20-499 of SEQ ID NO: 4 of at least 85%, at least 90%, at least 91%, at least 92%, at least 93%, at least 94%, at least 95%, at least 96%, at least 97%, at least 98%, at least 99%, or 100%, which have carbohydrate oxidase activity.

27. The method according to claim 15, wherein the reduction in color is obtained by removal of color which is not a melanoidin.
